(19) United States
(12) Patent Application Publication
(10) Pub. No.: US 2011/0219423 A1
(43) Pub. Date: Sep. 8, 2011

(54) METHOD AND APPARATUS FOR TRIGGERING USER COMMUNICATIONS BASED ON PRIVACY INFORMATION

(75) Inventors: Imad AAD, Preverenges (CH); Julien Freudiger, Lausanne (CH); Murtuza Jadliwala, Ecublens (CH); Jean-Pierre Hubaux, St-Sulpice (CH); Maxim Raya, Zurich (CH); Kari Leppänen, Helsinki (FI); Markku T. Turunen, Helsinki (FI)

(73) Assignee: Nokia Corporation, Espoo (FI)

(21) Appl. No.: 12/718,521

(22) Filed: Mar. 5, 2010

(51) Int. Cl. G06F 21/00

(52) U.S. Cl. 726/1

(57) ABSTRACT

An approach is provided for protecting a user identity in communication based on privacy information. The privacy engine selects one or more parameters associated with a privacy metric. Next, the privacy engine determines the parameters in a communication environment, the communication environment including a user device and a plurality of other devices. Next, the privacy engine computes a privacy level based, at least in part, on the parameters and the privacy metric. Next, the privacy engine compares the computed privacy level against a predetermined privacy level. Then, the privacy engine triggers a communication to one or more of the other devices in the communication environment based, at least in part, on the comparison.

### BACKGROUND

Service providers (e.g., wireless, cellular, etc.) and device manufacturers are continually challenged to deliver value and convenience to consumers by, for example, providing compelling network services. One area of development has been services and applications related to pervasive networks (e.g., peer-to-peer ad hoc mesh networks) in which users can communicate or otherwise exchange messages, data, information, etc. over an amorphous and constantly changing network topology or environment. Under such a network environment, messages or communications often are transported via multiple access technologies (e.g., cellular, wireless, wired, etc.) over any number of network nodes. The heterogeneity of the pervasive networks, for instance, offers the advantages of being able to establish ad-hoc links with nearby devices for transporting communication data even when a central or traditional network (e.g., a cellular network, the Internet, etc.) is not available. However, the heterogeneity of the network also makes protecting the privacy and anonymity of user communications extremely challenging. As a result, service providers and device manufactures face significant technical challenges to ensure that communications (particularly those involving sensitive information) transmitted over pervasive networks or similar network environments are protected against interception or eavesdropping.

### SOME EXAMPLE EMBODIMENTS

Therefore, there is a need for an approach for protecting a user communications and related information based on privacy information regarding a network environment.

According to one embodiment, a method comprises selecting one or more parameters associated with a privacy metric. The method also comprises determining the parameters in a communication environment, the communication environment including a user device and a plurality of other devices. The method further comprises computing a privacy level based, at least in part, on the parameters and the privacy metric. The method further comprises comparing the computed privacy level against a predetermined privacy level. The method further comprises triggering a communication to one or more of the other devices in the communication environment based, at least in part, on the comparison.

According to another embodiment, an apparatus comprising at least one processor, and at least one memory including computer program code, the at least one memory and the computer program code configured to, with the at least one processor, cause, at least in part, the apparatus to select one or more parameters associated with a privacy metric. The apparatus is also caused to determine the parameters in a communication environment, the communication environment including a user device and a plurality of other devices. The apparatus is further caused to compute a privacy level based, at least in part, on the parameters and the privacy metric. The apparatus is further caused to compare the computed privacy level against a predetermined privacy level. The apparatus is further caused to trigger a communication to one or more of the other devices in the communication environment based, at least in part, on the comparison.

According to another embodiment, a computer-readable storage medium carrying one or more sequences of one or more instructions which, when executed by one or more processors, cause, at least in part, an apparatus to select one or more parameters associated with a privacy metric. The apparatus is also caused to determine the parameters in a communication environment, the communication environment including a user device and a plurality of other devices. The apparatus is also caused to compute a privacy level based, at least in part, on the parameters and the privacy metric. The apparatus is further caused to compare the computed privacy level against a predetermined privacy level. The apparatus is further caused to trigger a communication to one or more of the other devices in the communication environment based, at least in part, on the comparison.

According to another embodiment, an apparatus comprises means for selecting one or more parameters associated with a privacy metric. The apparatus also comprises means for determining the parameters in a communication environment, the communication environment including a user device and a plurality of other devices. The apparatus further comprises means for computing a privacy level based, at least in part, on the parameters and the privacy metric. The apparatus further comprises means for comparing the computed privacy level against a predetermined privacy level. The apparatus further comprises means for triggering a communication to one or more of the other devices in the communication environment based, at least in part, on the comparison.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of triggering user communications based on privacy information, according to one embodiment;

FIGS. 2A-2D are diagrams of the components and subcomponents of a privacy engine, according to one embodiment;

FIG. 3 is a flowchart of a process for triggering user communications based on privacy information, according to one embodiment;

FIG. 4 is a flowchart of a process for triggering user communications based on supplemental information about a network environment, according to one embodiment;

FIGS. 5A-5D are diagrams of user interfaces utilized in the processes of FIG. 3, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for triggering user communications based on privacy information regarding a network environment are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

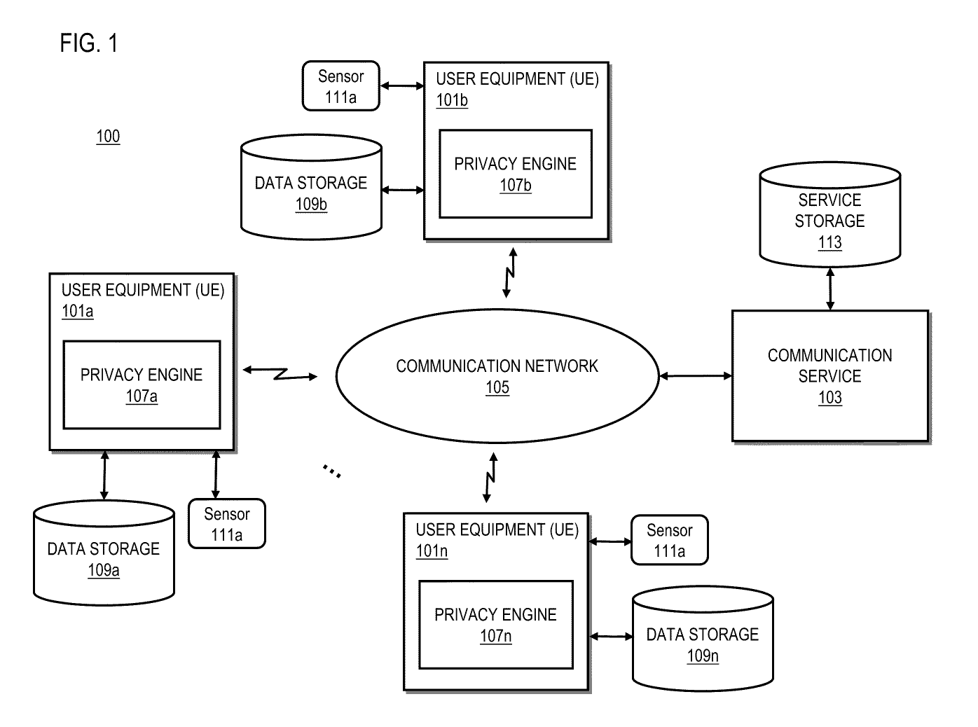

FIG. 1 is a diagram of a system capable of triggering user communications based on privacy information, according to one embodiment. Although various embodiments discuss privacy protection with respect to a pervasive network, it is contemplated the approach described herein applies to any type of communication network. As discussed previously, privacy protection of user communications within, for instance, a pervasive network, is a challenge. Historically, in order to protect the user's privacy during communication sessions, the content of the communication may be securely protected (e.g., encryption, restricted access, etc.) or the user's identity may be securely protected (e.g., through anonymization, etc.). For example, the user communication may be password protected such that only the intended recipient may be able to access the communication or the user's identity information may be stripped from the communication. The user may also want to protect his or her identity to remain anonymous and prevent others (e.g., recipients, interceptors, eavesdroppers, etc.) from knowing who sent the communication.

However, in some cases, these traditional approaches are not sufficient to protect a user's privacy. For example, encryption or similar forms of content protection may not be appropriate when the user wants to broadcast a public statement or provide public information (e.g., to provide a review of restaurant to nearby users, make a political statement, profile anonymous profile information, etc.) because the encryption would make the communication inaccessible or less accessible. Moreover, anonymization of the public communication (e.g., by removing sender identity information from the communication) may not be effective when, for instance, the density of communicating devices within a particular environment is low.

For example, if the user sends a public communication (e.g., unencrypted communication) to other devices in a communication environment having only a small number of people and/or communicating devices, it is easier for other people to discover who sent the communication through simple observation. On the other hand, if a user communicates within an environment with a large number of people or devices, the user may not be easily distinguishable to an eavesdropper or other observer. Thus, a user may be reluctant to communicate or send messages (e.g., particularly messages containing sensitive information) when there is uncertainty over whether the communication environment can adequately mask or protect the user's identity and/or information.

To address this problem, a system 100 of FIG. 1 introduces the capability to consider privacy conditions or privacy levels available within a user's communication environment and then trigger a user communication when the environment can support a predetermined level of privacy protection. In one embodiment, the system 100 determines parameters associated with a privacy metric in order to compute a privacy level for the environment around a user equipment (UE) 101, and initiates a communication based on the privacy level computed according to the determined parameters. As used herein, the term “privacy metric” refers to any measure or criteria associated with determining a privacy level (e.g., density of communicating devices, distances between devices, rate of communications among nearby devices, etc.). More specifically, the system 100 enables the UE 101 to acquire information about the surrounding network environment according a specified privacy metric (e.g. distances between the devices, the number of user devices in one area, network load, and like information) as well as content of the communication. For example, it is contemplated that this information may be acquired by a sensor 111, reports from the UE 101 itself, monitoring of the communication network 105, reports from other devices, and the like. This information includes, for instance, parameters that may represent or affect the privacy level of the UE 101, and thus the system 100 may use these parameters to compute a privacy level (e.g., using an algorithm for computing the privacy level). These parameters may be weighted differently, and the weights for the parameters may be customized by the user. Then, system 100 compares the computed privacy level against a predetermined privacy level to determine whether the acquired information indicates a privacy level that reaches the predetermined privacy level.

If the computed privacy level does not reach the predetermined privacy level, then this may suggest that the user of the UE 101 has less privacy than the user desires. In this case, the system 100 may apply a different setting (e.g., keep the communication data buffered until the privacy level reaches the required threshold) for communications by the UE 101.

For example, the system 100 may delay the communication, hide the identity of the user using the UE 101, make the user of the UE 101 anonymous, encrypt the communication, obscure the content of the communication, etc. Once the desired level of privacy is reached (e.g., the density of communicating devices has increased to predetermined levels), the system 100 can trigger or otherwise request the triggering of the communication.

In another embodiment, information from multiple user devices is used in computing a privacy level. For example, to compute a privacy level for the UE 101a, the information from the UE 101a as well as the information from the UEs 101b-101n may be considered. More specifically, context information associated with the UEs 101a-101n and the communication environment may be considered in computing a privacy level. Further, the computed privacy level from the devices other than the UEs 101a-101n (e.g., context information for another component, server, etc. of the communication network 105) may be considered in computing the privacy level for the UE 101a.

Therefore, an advantage of this approach described herein is that the UE 101 can dynamically compute or determine the privacy level available at the time the user makes a request to initiate a communication and then protect the privacy of the communication accordingly (e.g., delaying the communication until the communication environment can support a requested level of privacy). As noted, in one embodiment, information surrounding the UE 101 and the content of the communication by the UE 101 are considered in computing the privacy level. Based on the privacy level, actions can then be triggered to protect the privacy or anonymity of the communication including waiting for desired level of privacy level to be achieved before conducting the communication. In this way, this approach protects the user communication from potential eavesdroppers or privacy attackers, by considering the privacy level and make the user anonymous based on the privacy level. Therefore, means for protecting user identity in user communication based on surrounding information is anticipated.

As shown in FIG. 1, the system 100 comprises user equipment (UEs) 101a-101n having connectivity to one another and/or a communication service 103, via a communication network 105. In one embodiment, the communication service 103 provides a network service (e.g. broadcast service) or a web service (e.g., email service, messaging service, music service, mapping service, video service, social networking service, etc.) for access by the UE 101. Further, the UEs 101a-101n and/or the communication service 103 may be capable of broadcasting a message to other UEs 101a-101n using the communication network 105, and request a reply or any other type of interaction. The communication service 103 may have a service storage 113 to store communication data between the UEs 101a-101n and the communication service 103. For example, the communication service 103 may broadcast a survey question to the users of the UEs 101a-101n, and when the users' responses to the survey questions may be stored in the service storage 113.

The UE 101 may include a privacy engine 107. In one embodiment, the privacy engine 107 processes acquired data including information surrounding the UE 101. The information surrounding the UE 101 may include information collected from the sensor 111 as well as information about the user communication, and this information may be stored in the data storage 109 to be used by the privacy engine 107 for computation of a privacy level. This information surrounding the UE 101 may be an indication of the level of user privacy that the user of the UE 101 can enjoy. Thus, the privacy engine 107 analyzes the acquired data to compute a privacy level based on the acquired data. In more detail, the privacy engine 107 enables setting a predetermined privacy level, where the predetermined privacy level is a threshold that the computed privacy level is compared against. If the environment surrounding the UE 101 does not allow the user of the UE 101 to enjoy privacy of the predetermined privacy level, then the computed privacy level computed based on the information surrounding the UE 101 would not reach the predetermined privacy level, indicating that the user's identity in communication may need to be protected. One way that the privacy engine 107 protects the user's identity may be waiting until the computed privacy level reaches the predetermined privacy level to send communication. The predetermined privacy level may be set automatically, by a user or by an operator of the communication network 105 or the communication service 103.

In another embodiment, the sensor 111 may collect information related to context information of the environment surrounding the UE 101 as well as other user devices. This context information may also be used as supplementary information in computation of a privacy level by the privacy engine 107.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof.

In one embodiment, the UEs 101a-101n form a pervasive ad-hoc mesh network as part of the communication network 105 for communicating and exchanging information. The ad-hoc mesh network is, for instance, a connectionless and serverless device-to-device network (e.g., a mobile ad-hoc network (MANET)) created using short-range radio technology (e.g., wireless local area network (WLAN) or Bluetooth®). Within the ad-hoc mesh network, each UE 101 may be mobile and is within communication range of any number of other UEs 101. Accordingly, the set of UEs 101a-101n that is within communication range of any particular wireless node 101a is transient and can change as the wireless nodes 101a-101n move from location to location. As used herein, the term “connectionless” refers to the ability of a device (e.g., UE 101a) to send, and of all other surrounding UEs 101b-101n to receive, communications without the need to send any prior control signaling. For example, sending communications using the transmission control protocol/IP (TCP/IP) over a WLAN ad-hoc is not connectionless because of the two-way TCP control signaling between the sending and receiving nodes or devices used to establish the TCP connection. By way of example, communications among the nodes are provided, for instance, in small anonymous messages that are exchanged by the UEs nodes 101a-101n. In certain instances, the communications can be automatically exchanged without direct user intervention (e.g., when communications are buffered for transmission, when automatically transmitting or replying to queries among the devices, etc.). As used herein, the term “anonymous” means that it is not possible to infer the true identity of the sender from the message, unless the true identity is intentionally included in the message (e.g., by the user or another entity authorized by the user). The exchange of communications can occur as a broadcast message (e.g., a flooding message) from one UE 101a to neighboring UEs 101b-101n that are within range of the radio of the broadcasting UE 101a. As neighboring UEs 101b-101n receive the broadcasted message, each receiving UE 101b-101n may in turn rebroadcast the message to other neighboring UEs 101. In this way, the originally broadcasted message propagates throughout the ad-hoc mesh network, which can potentially increase privacy concerns if no privacy protection is applied. In exemplary embodiments, the extent of the propagation may be limited by criteria such as distance, location, time, etc.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UEs 101a-101n and the communication service 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

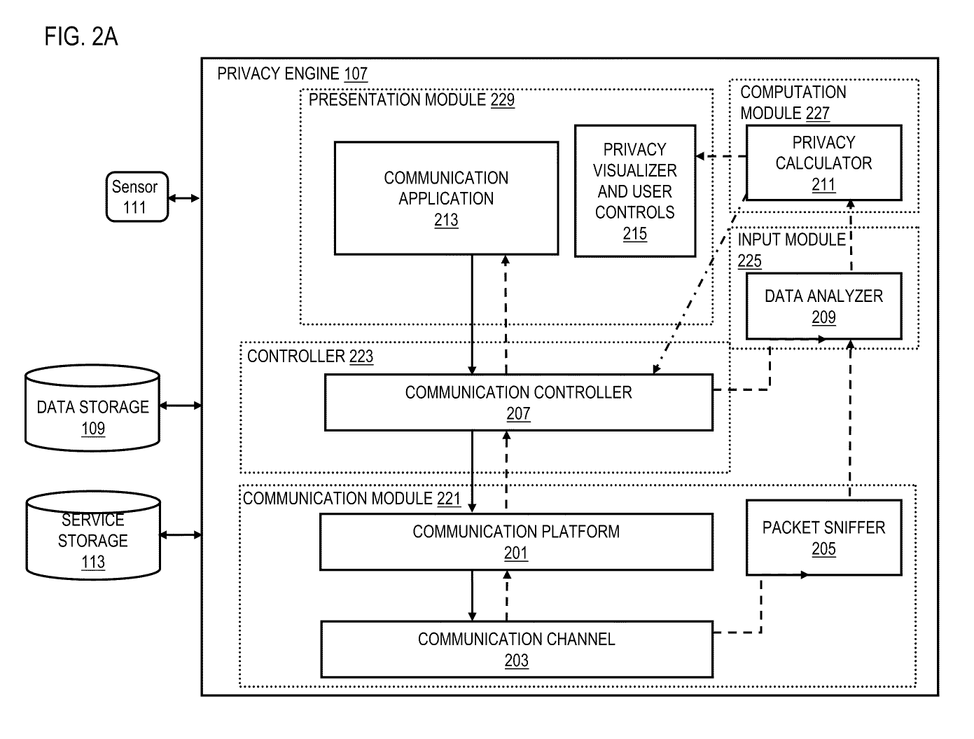

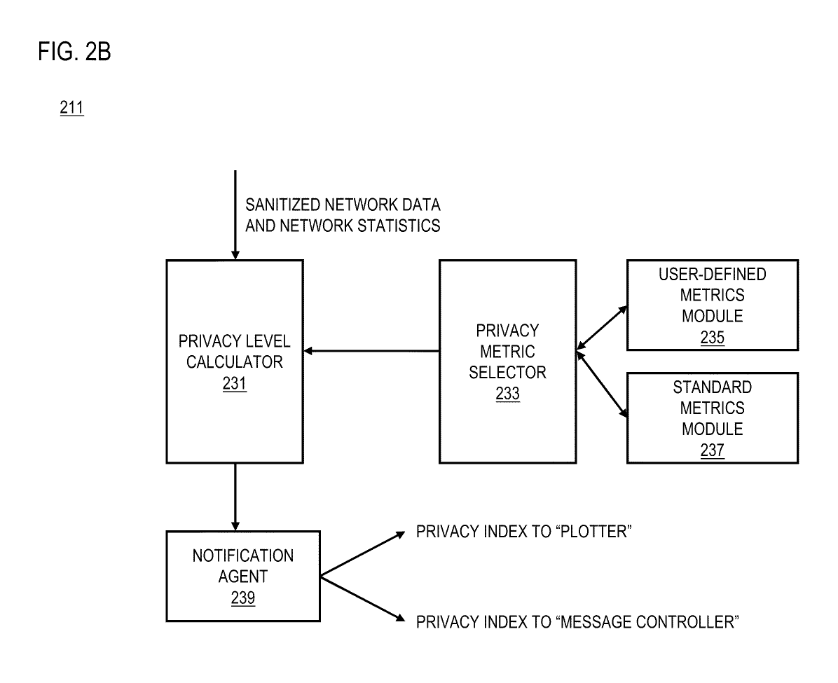

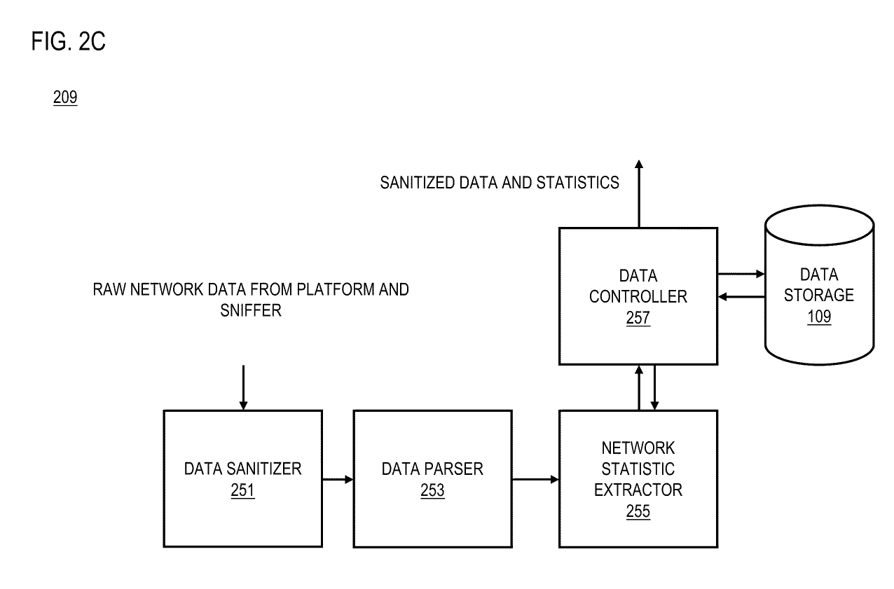

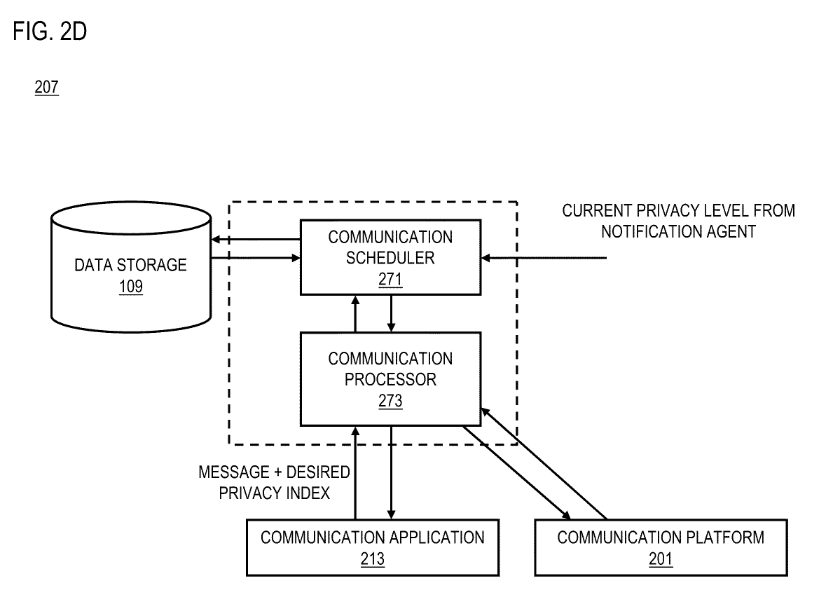

FIGS. 2A-2D are diagrams of the components and subcomponents of a privacy engine 107, according to one embodiment. It is contemplated that the functions of these components may be combined in one or more components or performed by other components of equivalent functionality. FIG. 2A shows components of the privacy engine 107, according to one embodiment. In this embodiment, the privacy engine 107 includes a communication module 221 for receiving and sending communication into and out of the UE 101, a controller 223 for controlling flow of information into and out of the UE 101, an input module 225 for preparing acquired data for computations, a computation module 227 for performing various computations, a presentation module 229 for gathering information to display on an interface. The presentation module 229 includes a communication application 213 and a privacy visualizer and user controls 215. The communication application 213 enables a user to select sending, receiving or forwarding of communication. Thus, the communication application 213 may enable the user to select recipients of user communication and to initiate communication (e.g. accept voice communication or compose messages). In one embodiment, the communication application may work in conjunction with a packet sniffer 205 that can capture network traffic. The privacy visualizer and user controls 215 provide an interface for viewing a current (computed) privacy level of the user and for setting a predetermined privacy level for user communications. In one embodiment, although the UE 101 may have the feature of this approach to trigger communication based on the privacy level, devices of other users do not have to have this feature of the UE 101 to perform processes described herein. The privacy engine 107 also includes a controller 223 which, in turn, includes a communication controller 207. The privacy engine further includes a computation module 227 including a privacy calculator 211 and an input module 225 including a data analyzer 209.

The communication module 221 is used to send or receive communication in the UE 101. The communication module 221 includes a communication channel 203 to send or receive communication, a communication platform 201 to receive communication from the communication controller 207 so that the communication can be sent out of the UE 101 via the communication channel 203, and to receive communication received by the UE 101 via the communication channel 203 and to send it to the communication controller 207. The communication module 221 also includes a packet sniffer 205 that can capture network traffic that goes through the communication channel 203.

FIG. 2B shows components of the privacy calculator 211, according to one embodiment. In this embodiment, the privacy calculator 211 includes a privacy level calculator 231, a privacy metric selector 233, a user-defined metrics module 235, a standard metric module 237 and a notification agent 239. The privacy metric selector 233 enables the user to select from different types of privacy metrics. The types of privacy metrics may include a user-defined privacy metrics as well as standard privacy metrics. The user-defined privacy metrics may be configured using the user-defined metrics module 235. The standard metrics module may be managed by the standard metrics module 237. Each privacy metric has different combination of parameters associated with the respective privacy metric. For example, as noted previously, a privacy metric may be based on distances between devices, density of devices, frequency of communications, communication traffic, and/or the like. It is contemplated that the approach describe herein is applicable to any privacy metric or combination of privacy metrics.

In one embodiment, the privacy metric selected by the privacy metric selector 233 is implemented in the privacy level calculator 231. The privacy level calculator 231 takes the sanitized network data and network statistics from the data analyzer 209, and computes a privacy level value based on the privacy metrics. In computing the privacy level, the parameters of the privacy metric are considered. The computed privacy level value is then sent to the notification agent 239 that issues one notification to a plotter (not shown) of the privacy visualize and user controls 215 such that the computed privacy level value can be displayed in a user interface of the UE 101 and another notification to the communication controller 207 such that the communication controller 207 can control the communication based on the computed privacy level value.

FIG. 2C shows components of the data analyzer 209, according to one embodiment. In this embodiment, the data analyzer 209 includes a data sanitizer 251, a data parser 253, a network statistic extractor 255 and a data controller 257. The data sanitizer 251 sanitizes raw network data from the communication platform 201 and the packet sniffer 205 by eliminating unwanted information (e.g., duplicate information or information not used in computation of privacy level value) from the raw network data. The sanitized data is then sent to the data parser 253, which captures specific information from the sanitized data based on pre-defined rules. This parsed data is then passed to the network statistic extractor 255 that aggregates information with the previously archived network data and statistics in order to generate and update the network statistics. The data controller 257 controls the information flow and archival of network data in the data storage 109 of the UE 101. The data controller 257 also sends the sanitized data and the latest network statistics to the privacy calculator 211.

FIG. 2D shows components of the communication controller 207, according to one embodiment. In this embodiment, the communication controller 207 includes a communication scheduler 271 and a communication processor 273. The communication scheduler 271 takes communications from the communication application 213 and the predetermined privacy level value from the privacy visualizer and user controls 215, and then schedules the communication in a local storage (e.g., the data storage 109) which can operate as a communication buffer. The communication scheduler 271 may also receive the computed current privacy level value from the notification agent 239 in a form of an interrupt signal. When the computed privacy level value is received as the interrupt signal, the communication scheduler 271 checks the data storage 109 for communication that needs to be transmitted and schedules delivery of the communication to the communication platform 201. During the scheduling of the delivery, the computed privacy level is compared against the predetermined privacy level, in order to determine how the communication will be communicated or whether the communication will be communicated. For example, if the computed privacy level is lower than the predetermined privacy level when the user tries to send communication, the user communication may be kept in the data storage 109, and then be sent once the surrounding environment causes the computed privacy level to reach the predetermined level. The communication processor 273 controls information flows to and from the communication scheduler 271, the communication application 213 and the communication platform 201.

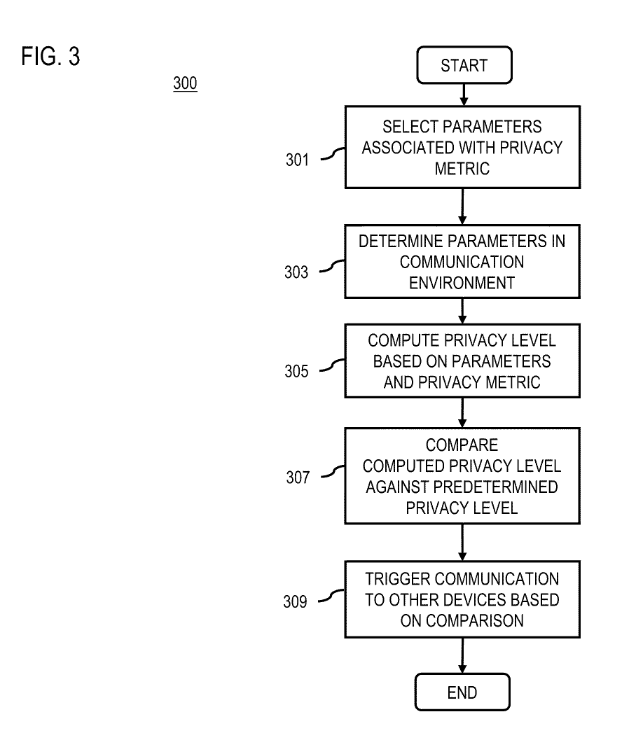

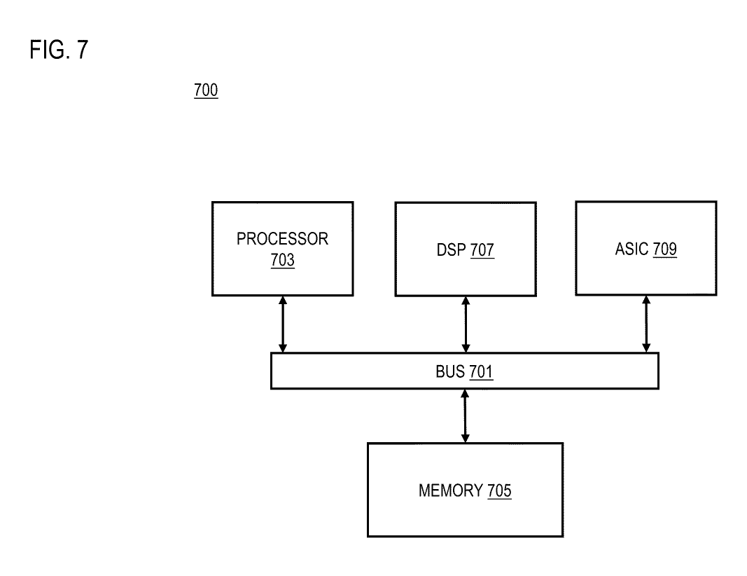

FIG. 3 is a flowchart of a process for triggering user communications based on privacy information, according to one embodiment. In one embodiment, the privacy engine 107 performs the process 300 and is implemented in, for instance, a chip set including a processor and a memory as shown FIG. 7. In step 301, the privacy engine 107 selects parameters associated with a privacy metric. The privacy metric may be a measure of the environment surrounding the UE 101 to hide the identity of the user of the UE 101, such that a third party may not be able to determine whether the UE 101 sends a user communication. The parameters associated with the privacy metric may include a density of the other devices surrounding the user device, a distance between the user device and a recipient device, a physical location of the user device, a time, a noise level, communication traffic in the communication environment, and content of the communication from the user device. Further, the number of devices around the UE 101 that are capable of communicating may be a parameter considered in computing the privacy level. Thus, the privacy engine 107 may enable the user to select one or more parameters associated with the privacy metric to compute a privacy level based on the parameters and the privacy level.

If there is a high number of devices surrounding the user device, then the user of the user device can “hide” among the numerous devices, and thus it is difficult for a third party to identify which device the user communication originated from. On the contrary, if there are only few devices surrounding the user device and the user sends communication, it will be easier for the third party to estimate which device the communication came from, because the third party would have to consider only a few devices as it attempts to estimate. Thus, in general, the higher the density of the other devices surrounding the user device is, the higher the privacy level is. Also, the closer the user device is to a recipient device, the easier it is for the recipient to identify the device, and thus closer distances may indicate lower privacy level. Further, the physical location of the user device as well as a time may determine the privacy level in that different locations may provide different privacy levels. For example, if the UE 101 is at a night club on a Saturday night, this may indicate that the privacy level is likely to be higher because night clubs are generally crowded on Saturday night and thus the UE 101 can easily hide in this crowd. On the contrary, if the UE 101 is at an accountant's office, the office is generally not very crowded and thus the privacy level is likely to be lower. In addition, a higher noise level may also indicate that there are many events happening in the environment surrounding the UE 101 and/or a large crowd of people are present around the UE 101, which may help the UE 101 stay hidden in such environment, and thus resulting in a higher privacy level. Moreover, if there is a lot of communication traffic (e.g., a high number of messages communicated during the last five minutes) around the UE 101, the communication by the UE 101 may be difficult to locate, and thus the privacy level would be higher. On the contrary, if the communication traffic is created only by the user (e.g. the user sending a lot of messages), but other users do not communicate much, then the user may be more visible and the privacy level may decrease. Further, the desired threshold for privacy may depend on the content of the communication from the user device, since some content of the communication may be more sensitive than others. The user may be able to flag the communication content as high privacy. Also, the UE 101 may be able to automatically determine the privacy level of the communication by key words contained in the message (e.g. a word indicating privacy such as “confidential” or “forward to everyone you know,” wherein the word “confidential” would trigger high privacy level and the word “forward to everyone you know” would trigger low privacy level). The word indicating privacy is also related to keeping the content of the communication private (e.g., “confidential”), then the communication may also be encrypted.

In step 303, the privacy engine 107 determines values of the parameters in the communication environment, wherein the communication environment includes a user device and other devices in, for instance, a pervasive network (e.g., an ad hoc mesh network). Then, in step 305, the privacy engine 107 computes a privacy level based on these selected parameters and the privacy metric. Each parameter will have its respective value depending on the environment conditions. Thus, the privacy engine 107 considers these parameter values of the selected parameters for the privacy metric and computes the privacy level. Then, as shown in step 307, the privacy engine 107 compares the computed privacy level against the predetermined privacy level, and then triggers the user communication to other devices based on the comparison. If the computed privacy level is equal or higher than the predetermined privacy level, then the user enjoys sufficiently high level of privacy, and thus the user's identity may not need to be protected during user communication. However, if the computed privacy level is lower than the predetermined privacy level, then the user does not enjoy sufficient privacy, and thus the user's identity needs to be protected.

This process is advantageous in that it provides a method to consider various types of information surrounding the UE 101 to compute a privacy level, and communicate based on the computed privacy level and the predetermined privacy level, in order to ensure protection of user identity in communication. The privacy engine 107 is a means for achieving this advantage.

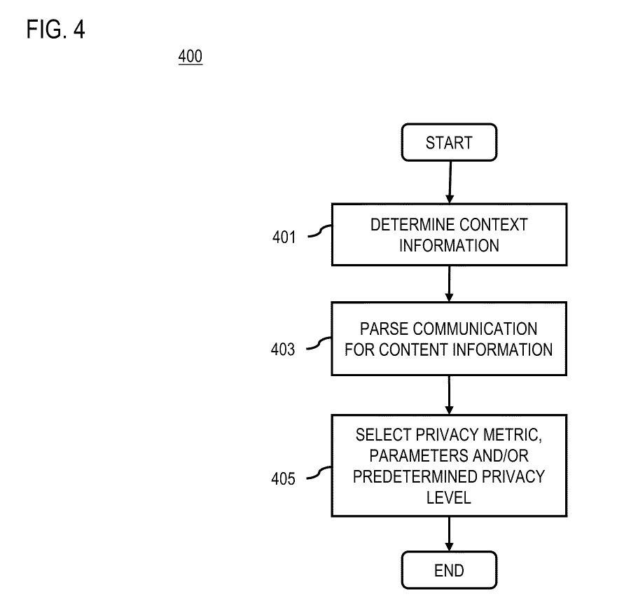

FIG. 4 is a flowchart of a process for triggering user communications based on supplemental information about a network environment, according to one embodiment. In one embodiment, the privacy engine 107 performs the process 400 and is implemented in, for instance, a chip set including a processor and a memory as shown FIG. 7. The privacy engine 107 may determine context information, as shown in step 401, and may parse user communication for content information of the communication, as shown in step 403. The order of steps 401 and 403 may be reversed. Alternatively, although not shown, either step 401 or step 403, not both, may take place. Then, as shown in step 405, the privacy engine 107 selects a privacy metric, parameters, a predetermined privacy level, or a combination thereof, based on the information obtained from step 401 and/or step 403. The context information may include user's current activities as well as surrounding environment. The examples of the context information may include driving, exercising, running, attending a meeting, and etc. The context information may be obtained via a sensor such as an accelerometer or a GPS device or noise level detector, or from a user's schedule saved in the UE 101 (e.g. the schedule indicating that the user is at a meeting or on a vacation). For example, if the context information indicates that the user is at a family dinner, then the privacy engine 107 may select the predetermined privacy level to low or adjust the predetermined privacy level to lower than what the user initially set. This may be because the user is likely to know everyone at the family dinner well enough that the user may not want to hide the user identity when the user communicates. In another example, if the context information indicates that the user is driving, the privacy metric for driving may be automatically selected so that parameters such as the noise level may not be considered. Because driving generally creates driving noise, the noise level may not have much value in determining the privacy level. In addition, if the content of the communication indicates that the communication is highly confidential (e.g., the subject line of the communication reads “confidential”), then the privacy engine 107 may set the predetermined privacy level to high or adjust the predetermined privacy level to higher.

Although not shown in the figures, the privacy engine 107 may additionally consider privacy levels of other devices when computing the privacy level. For example, if the computed privacy level of the user device is low, but many of the other devices surrounding the user device have high computed privacy level, then the computed privacy level may be adjusted to a higher level based on the computed privacy levels of the other devices. The degree that the other devices' computed privacy levels affect the user device's privacy level may be customizable. Further, although not shown, the privacy engine 107 may also consider privacy metrics of other devices in selecting the privacy metric of the user device.

This process is advantageous in that this method provides additional information to help determine the parameters and the privacy metrics as well as the predetermined privacy level by considering context information and/or content of the communication. The privacy engine 107 is a means for achieving this advantage.

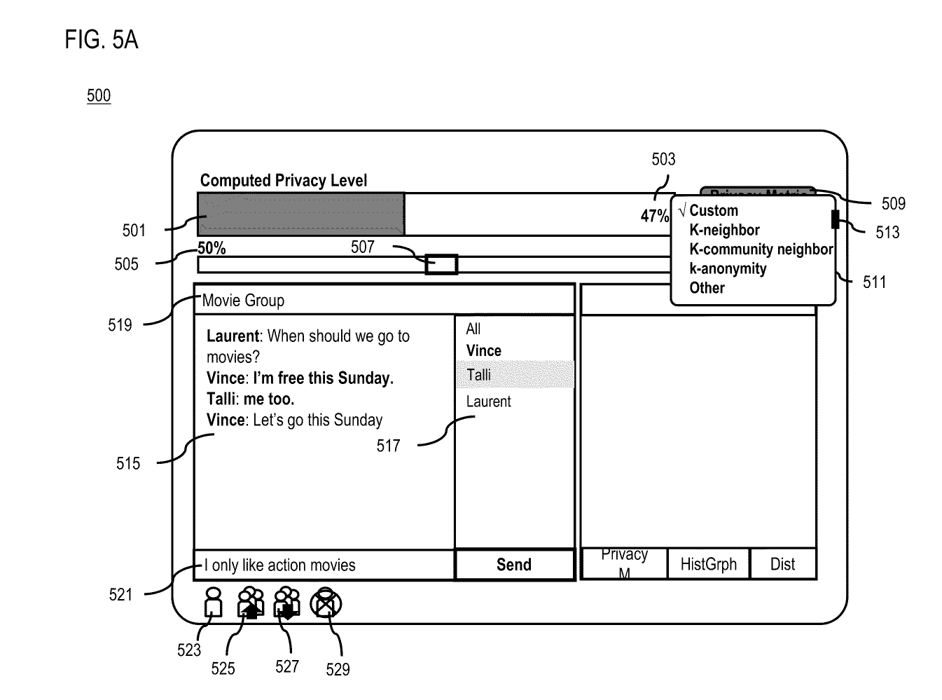

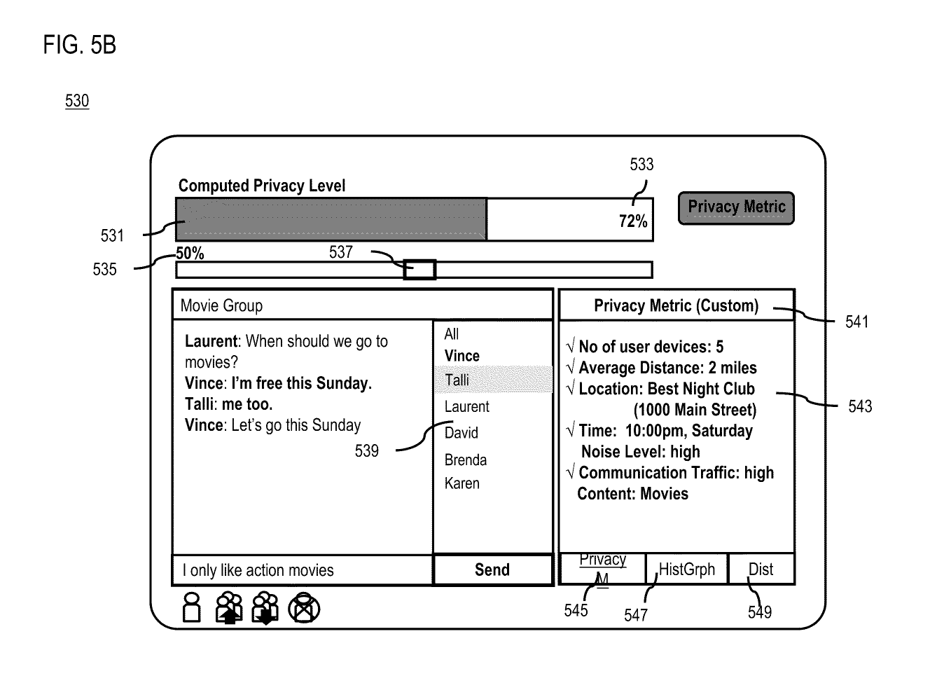

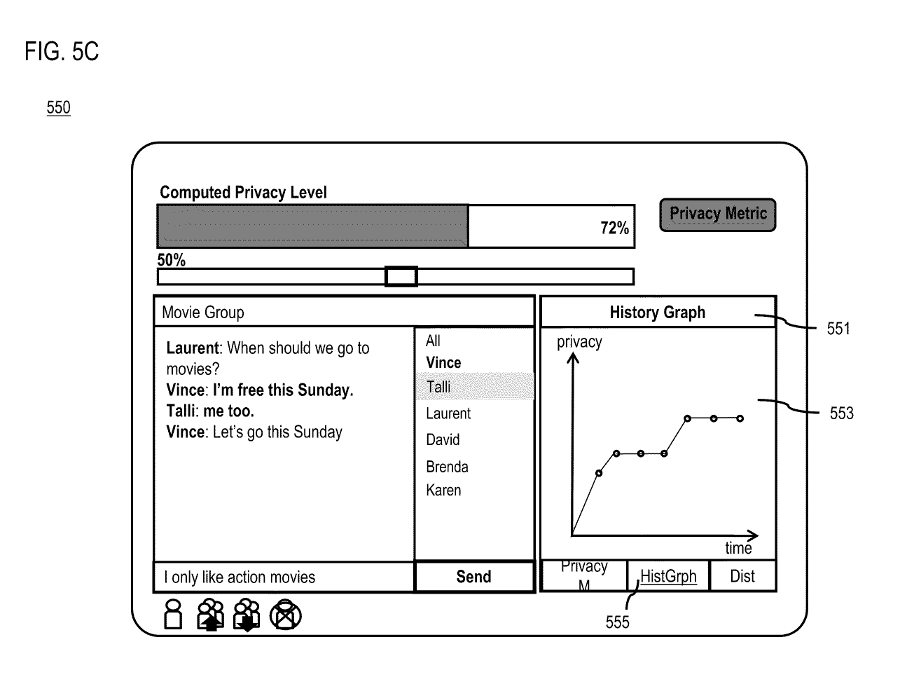

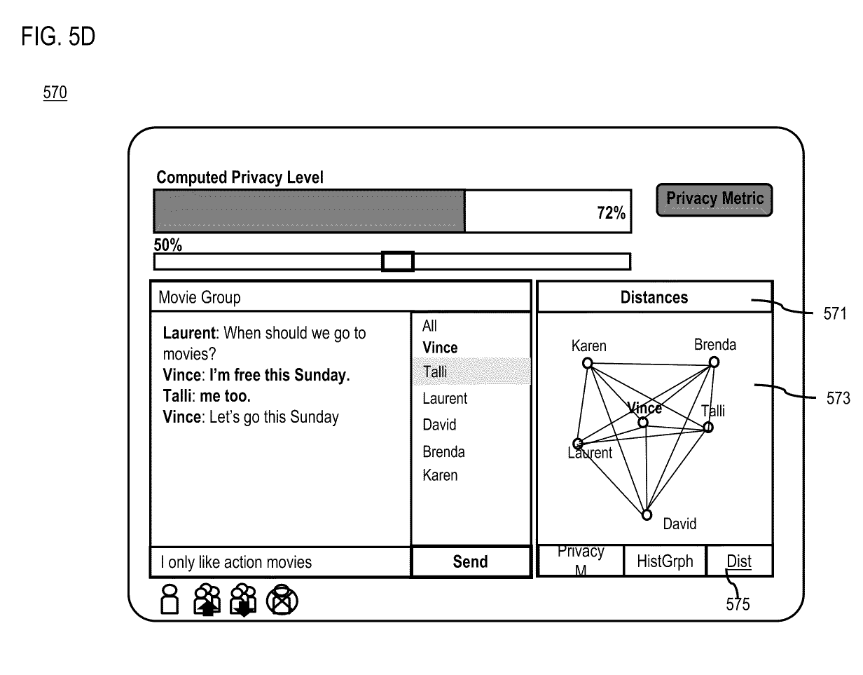

FIGS. 5A-5D are diagrams of user interfaces utilized in the processes of FIG. 3, according to various embodiments. FIG. 5A shows an example a user interface when three users (e.g., Vince, Talli and Laurent) have joined a communication group. A computed privacy meter 501 for a computed privacy level shown in a shaded bar, and the computed privacy number 503 representing the computed privacy level is shown on the right side of the privacy meter. In this example, the computed privacy level is 47%. A predetermined privacy number 505 representing the predetermined privacy level is shown on the left side of the predetermined privacy bar with a selection scroll 507. The selection scroll may be scrolled by a user to a desired predetermined privacy level, which is 50% in this example. The privacy metric option 509 may be selected to display the privacy metric option window 511. The privacy metric option window 511 shows a list of different privacy metrics that can be chosen. In this example, “Custom” privacy metric was chosen, as shown by a check mark. The scroll 513 may appear on the privacy metric option window 511 to allow scrolling up and down the window for more privacy metrics. The communication window 515 shows communication between users that joined a communication group. In this example, there are three users (e.g., Vince, Talli, Laurent) as shown in the users window 517, and the user joined the communication group called “Movie Group,” as shown in the communication title window 519. The main user is shown in a bold font in the users window 517, and thus the name of the user of the user device in this example is “Vince.” The users window 517 enables the selection of an individual or all the users within the group to communicate. In this example, Talli is selected to receive the communication, and thus the communication sent by the “Send” button at the message window 521 will be privately communicated to Talli only. The communication window 515 shows private communications in a bold font, and public communication in a normal font.

On the bottom of the user interface, there is a naming option 523, which allows the user to designate a name for the communication. In this example, the user has chosen the name “Vince.” The join group option 525 enables the user to join a communication group. In this example, the user has joined the communication group called “Movie Group.” The leave group option 527 enables the user to leave the communication group that the user has joined. Thus, the user can select the leave group option 527 if the user wants to leave the communication group “Movie Group,” in this example. The clear name option 529 enables the user to clear the name that the user has chosen via the naming option 523. In this example, because the computed privacy level is lower than the predetermined privacy level, any communication to be sent by the user of the user device need to be treated in a manner that protects the identity of the user. Thus, in this example, if the user tries to send a message, the message may not be sent immediately, but may be initially stored in the data storage 109. If the parameters associated with the privacy metric change to increase the computed privacy level to reach the predetermined privacy level, the message may then be sent.

FIG. 5B shows a user interface when six users have joined a communication group. As there are more users within the communication group in this example, the computed privacy level has increased from 47% to 72%. This is because it is more difficult to identify the user when there are more users in a group. Thus, the increased computed privacy level, which is 72%, is reflected in the computed privacy meter 531 and the computed privacy number 533. In this example, the computed privacy level (72%) is greater than the predetermined privacy level (50%) shown in the predetermined privacy number 535 and the selection scroll 537. For example, the privacy level is dependent on the number of users in the surrounding environment such as the users identified in window 539. Thus, the surrounding environment allows the user to enjoy sufficiently high privacy, and thus the user communication may be sent without any configuration to protect the identity of the user. Further, in FIG. 5B, the privacy metric setting was selected as “custom.” Therefore, the information title window 541 shows that the privacy metric is set to “custom.” There are three different types of information to display on the information window 543. These three types may be selected by selecting the three options, the privacy metric option 545, the history graph option 547 and the distance option 549. In this example, the privacy metric option 545 is selected to be displayed, as indicated by the underline of the word “Privacy M.” Thus, the information window 543 displays information about the privacy metric, such as parameters associated with the privacy metric.

The parameters available in this example are the number of devices, the average distance between the user device and other devices, the location of the user device, the current time, the noise level, the communication traffic and the content of the communication. In this example, the number of devices, the average distance between the user device and other devices, the location of the user device, the current time, and the communication traffic are selected as parameters to be considered in the “custom” privacy metric, as indicated by the check marks on the left side of the information window 543. This example shows that the parameters shown in this example contribute to increase in the computed privacy level. For example, there is an increased number of user devices, and thus it is easier for the user device to “hide” in the crowd of the user devices. Further, the fact that the user device is in a night club (Best Night Club) on Saturday night also indicates that the user device can “hide” in a crowd at the night club, which is generally crowded on Saturday night. Also, the high communication traffic contributes to the increase in the computed privacy level because the user communication can be difficult to identify if there is a high traffic of communication.

FIG. 5C shows a user interface when six users have joined a communication group, similar to FIG. 5B. The main difference between FIG. 5B and FIG. 5C is that FIG. 5C displays a history graph in the information window 553. The information title window 551 indicates that the information window 553 displays a history graph. This history graph shows a history of the computed privacy level in the past. The computed privacy level may be set to be computed at a predetermined time interval, and the computed privacy level at each time interval may be recorded such that the past computed privacy level may be plotted as a history graph of the computed privacy level. In this example, each circle represents a point where a privacy level is recorded. The horizontal axis represents time, and the vertical axis represents the privacy level. Further, the word “HistGraph” is underlined in the history graph option 555 to indicate that the history graph option 555 is selected.

FIG. 5D shows a user interface when six users have joined a communication group, similar to FIGS. 5C and 5D. The main difference between FIG. 5D and FIGS. 5C and 5D is that FIG. 5D displays a distance plot in the information window 553. The circles represent relative locations of the users, and the lines represent relative distances between the users. This distance plot provides the user an idea about where other users' devices are located. Thus, this may help the user to adjust a communication setting, depending on which one of the other users is close to the user. The word “Dist” is underlined in the distance option 575 to indicate that the distance option 575 is selected

The processes described herein for protecting a user identity in communication based on privacy information may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

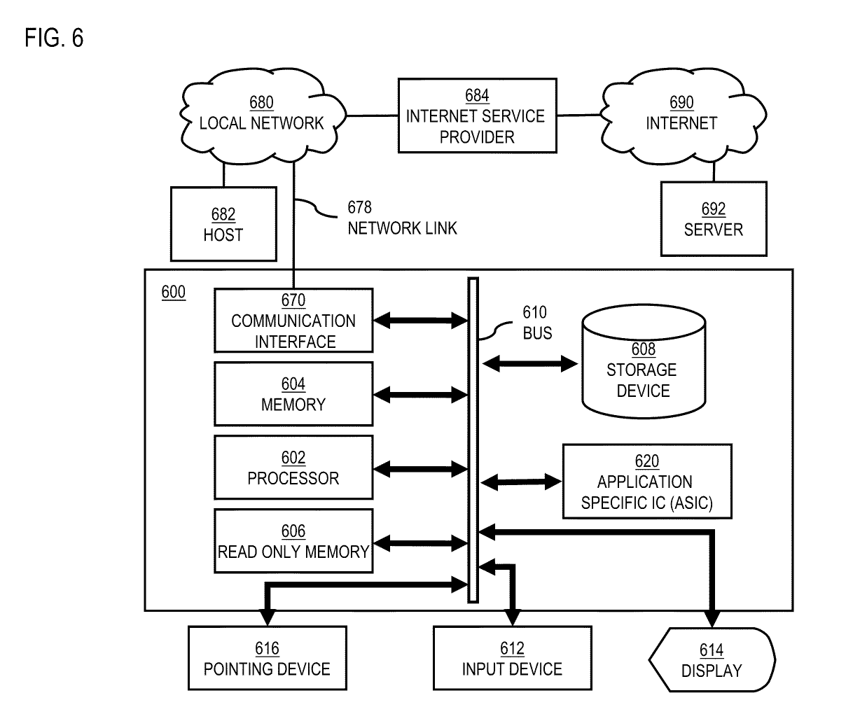

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to protect a user identity in communication based on privacy information as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of protecting a user identity in communication based on privacy information.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to protecting a user identity in communication based on privacy information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for protecting a user identity in communication based on privacy information. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for protecting a user identity in communication based on privacy information, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for protecting a user identity in communication based on privacy information.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set 700 upon which an embodiment of the invention may be implemented. Chip set 700 is programmed to protect a user identity in communication based on privacy information as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of protecting a user identity in communication based on privacy information.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to protect a user identity in communication based on privacy information. The memory 705 also stores the data associated with or generated by the execution of the inventive steps.

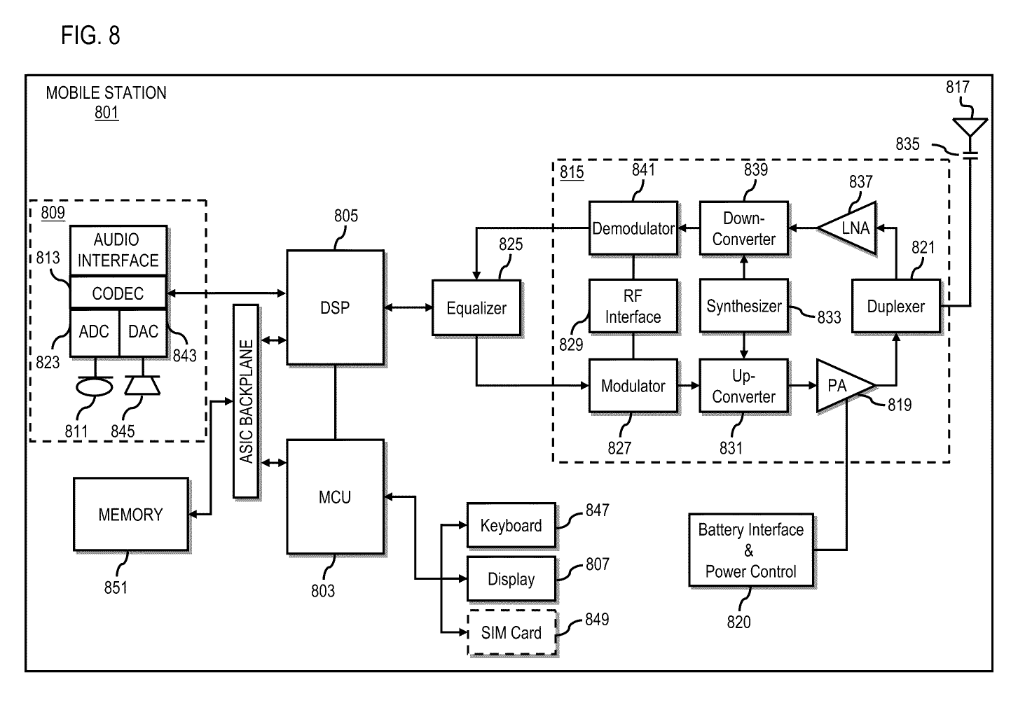

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of protecting a user identity in communication based on privacy information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of protecting a user identity in communication based on privacy information. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to protect a user identity in communication based on privacy information. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
selecting one or more parameters associated with a privacy metric;
determining the parameters in a communication environment, the communication environment including a user device and a plurality of other devices;
computing a privacy level based, at least in part, on the parameters and the privacy metric;
comparing the computed privacy level against a predetermined privacy level; and
triggering a communication to one or more of the other devices in the communication environment based, at least in part, on the comparison.

2. A method of claim 1, further comprising:
receiving another computed privacy level from a respective one or more of the other devices,
wherein the computed privacy level is based, at least in part, on the another computed privacy levels.

3. A method of claim 1, further comprising:
determining context information associated with the user device, the other devices, the communication environment, or a combination thereof;
selecting the privacy metric, the parameters, the predetermined privacy level, or a combination thereof based, at least in part, on the context information.

4. A method of claim 1, further comprising:
parsing the communication for content information; and
selecting the privacy metric, the parameters, the predetermined privacy level, or a combination thereof based, at least in part, on the content information.

5. A method of claim 1, further comprising:
causing, at least in part, a presentation of the computed privacy level, the predetermined privacy level, or a combination thereof.

6. A method of claim 1, wherein the parameters include a density of the other devices surrounding the user device, a distance between the user device and a recipient device, a physical location of the user device, a time, a noise level, communication traffic in the communication environment, and content of the communication from the user device.

7. A method of claim 1, wherein the privacy metric is a measure of an ability of the communication environment to obscure identity information associated with a user

8. A method of claim 1, wherein the communication is an anonymous broadcast message, an anonymous query, an anonymous reply to the query, or a combination thereof.

9. An apparatus comprising:
at least one processor; and
at least one memory including computer program code,
the at least one memory and the computer program code configured to, with the at least one processor, cause the apparatus to perform at least the following,
select one or more parameters associated with a privacy metric;
determine the parameters in a communication environment, the communication environment including a user device and a plurality of other devices;
compute a privacy level based, at least in part, on the parameters and the privacy metric;
compare the computed privacy level against a predetermined privacy level; and
trigger a communication to one or more of the other devices in the communication environment based, at least in part, on the comparison.

10. An apparatus of claim 9, wherein the apparatus is further caused, at least in part, to:
receive another computed privacy level from a respective one or more of the other devices,
wherein the computed privacy level is based, at least in part, on the another computed privacy levels.

11. An apparatus of claim 9, wherein the apparatus is further caused, at least in part, to:
determine context information associated with the user device, the other devices, the communication environment, or a combination thereof
select the privacy metric, the parameters, the predetermined privacy level, or a combination thereof based, at least in part, on the context information.

12. An apparatus of claim 9, wherein the apparatus is further caused, at least in part, to:
parse the communication for content information; and
select the privacy metric, the parameters, the predetermined privacy level, or a combination thereof based, at least in part, on the content information.

13. An apparatus of claim 9, wherein the apparatus is further caused, at least in part, to:
present the computed privacy level, the predetermined privacy level, or a combination thereof.

14. An apparatus of claim 9, wherein the parameters include a density of the other devices surrounding the user device, a distance between the user device and a recipient device, a physical location of the user device, a time, a noise level, communication traffic in the communication environment, and content of the communication from the user device.

15. An apparatus of claim 9, wherein the privacy metric is a measure of an ability of the communication environment to obscure identity information associated with a user

16. An apparatus of claim 9, wherein the communication is an anonymous broadcast message, an anonymous query, an anonymous reply to the query, or a combination thereof.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
selecting one or more parameters associated with a privacy metric;
determining the parameters in a communication environment, the communication environment including a user device and a plurality of other devices;
computing a privacy level based, at least in part, on the parameters and the privacy metric;
comparing the computed privacy level against a predetermined privacy level; and
triggering a communication to one or more of the other devices in the communication environment based, at least in part, on the comparison.

19. A computer-readable storage medium of claim 18, wherein the apparatus is caused, at least in part, to further perform:
receiving another computed privacy level from a respective one or more of the other devices,
wherein the computed privacy level is based, at least in part, on the another computed privacy levels.

20. A computer-readable storage medium of claim 18, wherein the apparatus is caused, at least in part, to further perform:
determining context information associated with the user device, the other devices, the communication environment, or a combination thereof;
parsing the communication for content information; and
selecting the privacy metric, the parameters, the predetermined privacy level, or a combination thereof based, at least in part, on the context information and the content information.
